(19) United States
(12) Patent Application Publication
(10) Pub. No.: US 2023/0165270 A1
(43) Pub. Date: Jun. 1, 2023

(54) Multi-Coated Frozen Dessert Bar

(71) Applicant: General Mills, Inc., Minneapolis, MN (US)

(72) Inventor: Andreas Schopf, Ste Foy les, Lyon (FR)

(73) Assignee: General Mills, Inc., Minneapolis, MN (US)

(21) Appl. No.: 17/922,648

(22) PCT Filed: May 26, 2020
(86) PCT No.: PCT/US2020/034544

§ 371 Date: Nov. 1, 2022

(51) Int. Cl. A23G 9/48; A23G 9/50; A23G 9/32

(52) U.S. Cl. CPC A23G 9/48; A23G 9/503; A23G 9/322

(57) ABSTRACT

A method of making a frozen dessert bar includes forming a plurality of spaced cavities in a main body of ice cream or frozen yogurt, with the plurality of spaced cavities being filled with distinct edible materials thereby coating the one or more exterior surface portions of the main body at the plurality of spaced cavities. The cavities can be formed in various ways, such as molding the main body with the cavities or stamping the cavities into a pre-formed main body. As the coating materials employed can significantly vary, a wide range of frozen dessert bars, with quite unique and interesting eating experiences, can be produced for consumers.

### BACKGROUND OF THE INVENTION

The invention generally pertains to forming a frozen dessert bar, such as an ice cream stick bar, with multiple, distinct coatings in different portions of the bar, thereby establishing a unique visual, taste and texture experience for a consumer.

Frozen dessert bars, such as ice cream and frozen yogurt bars, are widely known. Over the years, some emphasis has been placed on creating taste and texture variations to such known bars in order to appeal to the varying preferences of consumers. For instance, ice cream and frozen yogurt bars are now available in a wide range of flavors. In addition, the frozen bodies of the bars need not be uniform but rather can include discrete chunks of chocolate, cookie dough or the like. It is also known to create swirls of different flavored ice cream or yogurt. Furthermore, it is known to apply a coating and/or nuts on the exterior surface of the frozen body.

One extremely common dessert bar variation is the coating of an entire outer surface of an ice cream stick bar in chocolate. Although this known type of product is quite popular, it is quite uniform in both taste and texture. Basically, every bite of the product provides a fairly consistent ratio of ice cream and chocolate. Again, this has proven to be a popular product, but still there is seen to be a benefit in providing more variation in both the taste and texture of frozen dessert bars, enabling consumers to experience multiple, unique sensory variations upon consumption.

Based on the above, regardless of these known frozen dessert products, there is still seen to be a need in the art for frozen dessert bars which include multiple distinct coatings spaced about one or more exterior surface portions of the bars, with the coatings providing, in combination with the main dessert body, a wide range of sensory variations upon eating the bars.

### SUMMARY OF THE INVENTION

The present invention establishes a frozen dessert bar by forming a plurality of spaced cavities in a main body of ice cream or frozen yogurt, with the plurality of spaced cavities opening to one or more exterior surface portions of the main body and the main body having a handle member projecting from within the main body to enable supporting the main body by a hand of a consumer. The plurality of spaced cavities are filled with distinct edible materials, thereby coating the one or more exterior surface portions of the main body at the plurality of spaced cavities. The cavities can be formed in various ways, such as molding the main body with the cavities or stamping the cavities into a pre-formed main body.

In preferred embodiments of the invention, first and second sets of cavities are formed so as to be exposed across opposing major faces of the main body, with the cavities on one major face being filled with coating materials which are hardened into filler pieces prior to flipping the bar in order to fill the cavities on the opposing major face.

A wide range of frozen dessert bars can be made in accordance with the invention, with each frozen dessert bar including a main body of ice cream or frozen yogurt with a plurality of spaced cavities opening to one or more exterior surface portions of the main body, a handle piece projecting from the main body to enable supporting the main body by a hand of a consumer, and a plurality of distinct, edible filler pieces provided in the plurality of spaced cavities. As the coating material employed can significantly vary, quite unique and interesting eating experiences will be available to consumers for such dessert bars.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a perspective, partially exploded view of a coated ice cream bar known in the art;

FIG. 2 is a partially exploded, perspective view of a frozen dessert bar made in accordance with the present invention; and

FIG. 3 is a flow chart schematically illustrating the making of frozen dessert bars in accordance with the invention.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art how to practice the present invention.

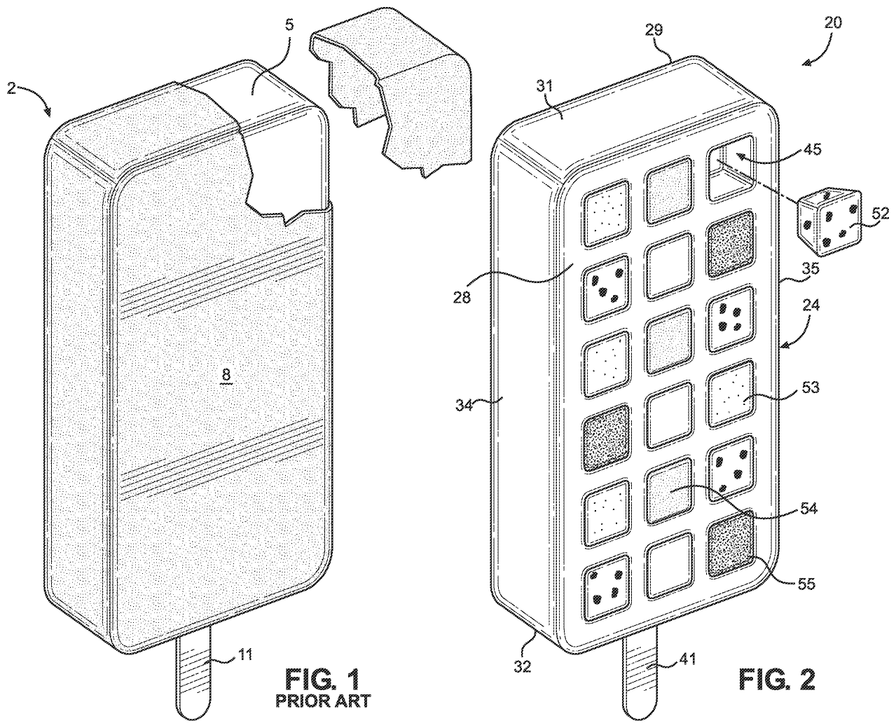

With initial reference to FIG. 1, a frozen dessert product in the form of an ice cream bar produced in accordance with the prior art is generally indicated at 2. In general, ice cream bar 2 has a main body 5 made from a flavored ice cream, for example vanilla ice cream. Main body 5 is provided with an outer coating 8, such as a thin chocolate coating. For handling ice cream bar 2, a stick 11 projects from main body 5. Again, this type of ice cream bar has been widely known in the art for generations, providing for a quite uniform taste and texture in every bite. Basically, every bite of the product provides a fairly consistent ratio of ice cream and chocolate.

As shown in FIG. 2, a frozen dessert bar made in accordance with the present invention is generally indicated at 20. For purposes of explaining the invention, reference will be made to particular embodiments wherein frozen dessert bar 20 is an ice cream bar. However, frozen dessert bar 20 can take other forms, particularly a frozen yogurt bar.

As shown, frozen dessert bar 20 has a main body 24 having various exterior surface portions defined by opposing face portions 28 and 29, top and bottom portions 31 and 32, and opposing side portions 34 and 35. Although shown to be generally rectangular in shape, frozen dessert bar 20 could take a wide range of shapes, basically any polygonal or non-polygonal shape, without departing from the invention. As with ice cream bar 2, frozen dessert bar 20 includes a handle member 41, shown in the form of a stick projecting from bottom portion 32 of main body 24.

Important in connection with the present invention is that main body 24 is provided or formed with a plurality of spaced compartments or cavities, with one such cavity being indicated at 45. Created in cavities 45 are respective edible filler pieces, such as indicated at 52-55. Although filler pieces 52-55 could be made of the some common ingredient(s), in accordance with most preferred embodiments of the invention, at least certain ones of filler pieces 52-55 are made from distinct edible materials.

In the embodiment shown, main body 24 is formed with eighteen cavities 45 spaced about front face portion 28. Main body 24 preferably has a thickness of at least 12 mm and each of the cavities 45 extends into main body 24 to a depth less than the thickness of main body 24, preferably between 2-5 mm. Additional cavities 45 could be exposed on one or more other exterior surfaces of main body 24. In fact, in a particularly preferred embodiment, a corresponding number of cavities are also provided about rear face portion 29. Although not required, it is preferred that each filler piece 52-55 fills a respective cavity 45 so as to be substantially flush with its respective exterior surface of main body 24.

At this point, it should be recognized that cavities 45 can take a wide range of shapes and depths in accordance with the invention. In fact, the shapes and depths can vary between the various cavities 45. By way of example, although each cavity 45 shown in FIG. 2 is represented as a trapezoidal prism, other geometric shapes, include cone, cube, pyramid and cylinder shapes, could be employed. In addition, cavities 45 can be randomly spaced and can even combine to form a specific pattern. For instance, some cavities can be formed as flower pedals, while others could be mimic stems, such that an overall design is created. However, it is important in accordance with the invention that a plurality of cavities 45 be spaced from each other within main body 24. That is, as indicated above, it is desired to fill cavities 45 with different edible materials in order to establish an overall frozen dessert bar 20 which will provide for quite unique and interesting eating experiences to consumers by creating distinct taste and/or texture variations throughout the frozen dessert bar 20.

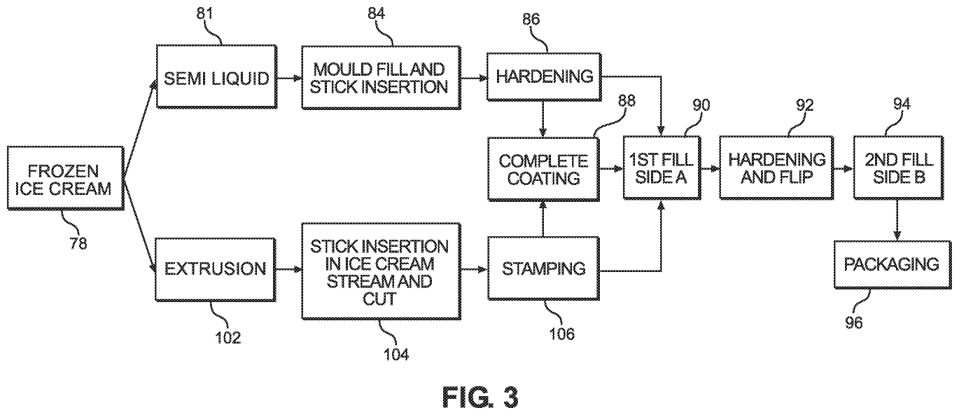

In connection with the invention, it should be noted that filler pieces 52-55 are not preformed and inserted into the cavities 45. Instead, each filler piece 52-55 represents a distinct coating for a portion of main body 24. That is, the plurality of cavities 45 are formed in main body 24 and subsequently, individually filled with different edible materials, thereby coating the one or more exterior surface portions of main body 24 at the plurality of spaced cavities 45. More specifically, reference will now be made to FIG. 3 which illustrates production processes associated with making frozen dessert bars 20 according to the invention, starting with frozen ice cream at 78. Typically, ice cream is maintained frozen at about between −12° C. to −18° C. (includes typical manufacturing, shipping and supermarket freezer temperatures). In FIG. 3, two different production paths are represented, i.e., a moulding path and an extrusion path. For the sake of simplicity and since the making of the ice cream itself is not part of the present invention, details for steps associated with, for example, homogenizing, pasteurizing, mixing, flavoring, aging and the like of the ice cream will not be detailed here.

As shown in FIG. 3, if a moulding process is selected, the frozen ice cream is initially heated to establish a semi-liquid, flowable consistency. By way of example, the ice cream can be heated to approximately −5.5° C. at step 81. Next, a mould designed to establish the desired overall shape for frozen dessert bar 20 and cavities 45 is filled with the semi-liquid ice cream at step 84 to form main body 24. At this time, the handle member 41 is also positioned partially within the mold. In step 86, the semi-liquid ice cream for main body 24 is hardened through a cooling operation.

At this point, an option is presented, basically depending upon whether frozen dessert bar 20 is to also include a common coating about an entirety of main body 24, with this common coating being analogous to the outer chocolate coating mentioned with reference to the prior art of FIG. 1. If such a common coating is desired, step 88 is performed. Obviously, different than the arrangement of FIG. 1, this common coating would also thinly coat the exposed inside surfaces of each cavity 45.

The next step is filling the plurality of spaced cavities 45 opening to one exterior surface portion, such as face portion 28, of main body 24 at 90 with various edible materials. Obviously, if step 88 is performed, these edible materials would covering part of the common coating. Again, although some of the cavities 45 may be provided with the same edible material, in accordance with the invention, a plurality of cavities 45 are coated with distinct edible materials in order to result in the varied taste and texture characteristics. Assuming the opposing rear face 29 is also formed with a plurality of cavities 45 during the moulding step, the edible materials in the cavities 45 across face portion 28 are hardened and the ice cream bar is flipped at 92. Then, the additional cavities 45 in face portion 29 are filled at 94 in a corresponding manner. If necessary, an additional hardening step (not shown) can be performed at this stage. Thereafter, the frozen dessert bar 20 can be packaged at 96.

In accordance the extrusion version of this production process, the frozen ice cream at 78 is extruded to form an elongated bar of ice cream at 102, such as at about −7° C. Next, a stick for handle member 41 is inserted in the ice cream and the elongated bar is cut to establish main body 24, albeit without the plurality of cavities 45 at this point. At step 106, a stamping operation is performed on main body 24 to create the plurality of cavities 45. Step 106 can be performed in various ways, such as through the use of a roller mold or vertical stamping machines. After the pluralities of cavities 45 are formed, the process next proceeds to either step 88 or 90, and then through to packaging step 96, in the exact manner described above.

In connection with each of the embodiments of the invention, a wide range of edible materials can be employed for filling the cavities. For instance, the cavities can be filled with: different chocolates, including soft chocolate, dark chocolate and white chocolate; different pastes, such as almond, coconut, nut butter, peanut butter, cookie dough and the like; and different fruit flavored sauces, such as raspberry, cherry, blueberry, strawberry, etc.; and a variety of toppings including, but not limited to, caramel and butterscotch. In general, the selected edible material really need only possess the property enabling the same to be flowable for coating the cavities yet be capable of hardening as least to the point that the edible material will not flow out of its respective cavity when the frozen fruit bar is being held upright by a consumer. Therefore, many edible solid and semi-solid materials can be employed, so long as they meet these criteria.

Based on the above, it should be readily apparent that the present invention provides a way to effectively incorporate multiple, distinct coating filler materials as part of a frozen dessert bar, particularly in connection with the mass production of frozen dessert bars, to enable unique and interesting eating experiences for consumers. While certain preferred embodiments of the present invention have been set forth, it should be understood that various changes or modifications could be made without departing from the spirit of the present invention. In general, the invention is only intended to be limited by the scope of the following claims.

1. A method of making a frozen dessert bar comprising:
forming first and second spaced cavities in a main body of ice cream or frozen yogurt, with each of the first and second spaced cavities opening to a first exterior surface portion of the main body and the main body having a handle member projecting from the main body to enable supporting the main body by a hand of a consumer;
filling the first and second spaced cavities with first and second distinct edible materials, respectively; and
packaging the frozen dessert bar.

2. The method of claim 1, wherein filling the first and second edible materials are flowable and filling the first and second spaced cavities includes hardening the first and second edible materials.

3. The method of claim 2, further comprising forming a third cavity in the main body, with the third cavity opening to a second exterior surface portion of the main body; and after hardening the first and second edible materials, flipping the main body and filling the third cavity with a third edible material.

4. The method of claim 1, wherein filling the first and second spaced cavities includes filling the first and second spaced cavities with the first and second edible materials, respectively, such that the first and second edible materials are substantially flush with the first and second exterior surface of the main body.

5. The method of claim 2, wherein the first and second edible materials are selected from the group consisting of: chocolate, pastes, fruit flavored sauces and toppings.

6. The method of claim 1, wherein the main body is moulded about the handle member.

7. The method of claim 1, wherein the main body is extruded, with the handle member being inserted into the main body.

8. The method of claim 7, wherein forming the first and second spaced cavities includes stamping the extruded main body.

9. The method of claim 1, further comprising, prior to filling the first and second spaced cavities, providing a common coating about an entirety of the main body including upon the exposed inside surfaces of the first and second spaced cavities.

10. The method of claim 1, wherein each of the first and second spaced cavities extends into the main body to a depth less than a thickness of the main body.

11. The method of claim 10, wherein each of the first and second spaced cavities extends into the main body between 2-5 mm.

12. A frozen dessert bar comprising:
a main body of ice cream or frozen yogurt, said main body including with a first and second spaced cavities, with each of the first and second spaced cavities opening to a first exterior surface portion of the main body;
a handle member projecting from the main body to enable supporting the main body by a hand of a consumer; and
first and second distinct edible materials being provided in the first and second spaced cavities, respectively.

13. The frozen dessert bar of claim 13, wherein the main body further includes a second exterior surface portion opposing the first exterior surface portion and the second exterior portion includes a third cavity, with the third cavity opening to the second exterior surface portion.

14. The frozen dessert bar of claim 14, wherein the main body has a thickness which is greater than a depth of any of the first, second or third cavities such that none of the first, second or third cavities extends entirely through the main body.

15. The frozen dessert bar of claim 14, wherein each of the first, second and third cavities extends into the main body to a depth between 2-5 mm.

16. The frozen dessert bar of claim 12, wherein each of the first and second edible materials is substantially flush with first exterior surface portion.

17. The frozen dessert bar of claim 12, wherein the first and second distinct edible materials vary in flavors and/or textures.

18. The frozen dessert bar of claim 12, further comprising a common coating about an entirety of the main body and upon inside surfaces of the first and second spaced cavities, with the first and second edible materials covering part of the common coating.

19. The frozen dessert bar of claim 12, wherein the handle piece member comprises a stick and the frozen dessert bar constitutes an ice cream stick bar.
